(19) United States
(12) Patent Application Publication
(10) Pub. No.: US 2014/0223634 A1
(43) Pub. Date: Aug. 14, 2014

(54) DUAL LAYER COOLING FABRIC

(71) Applicant: RealXGear, Melissa, TX (US)

(72) Inventor: Chris Maher, Melissa, TX (US)

(73) Assignee: RealXGear, Melissa, TX (US)

(21) Appl. No.: 13/903,779

(22) Filed: May 28, 2013

Related U.S. Application Data
(60) Provisional application No. 61/764,632, filed on Feb. 14, 2013.

(51) Int. Cl. B32B 5/24

(52) U.S. Cl. CPC B32B 5/245
USPC 2/93; 2/200.1; 2/102; 2/69

(57) ABSTRACT

One example of a multi-layer fabric may include a PVA sponge layer, as well as a wicking layer disposed near the PVA sponge layer. The multi-layer fabric may be employed in clothing and/or other articles to facilitate achievement of a cooling effect relative to a wearer of the clothing or user of the article.

### RELATED APPLICATIONS

This application hereby claims priority to U.S. Provisional Patent Application Ser. No. 61/764,632, entitled DUAL LAYER COOLING FABRIC, filed Feb. 14, 2013, and incorporated herein in its entirety by this reference.

### BACKGROUND

The present disclosure is generally concerned with fabrics. More specifically, the disclosed embodiments concern a multi-layer fabric that may be employed in clothing to facilitate achievement of a cooling effect relative to a wearer of the clothing.

### BRIEF SUMMARY OF SOME ASPECTS OF THE DISCLOSURE

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

Disclosed embodiments are generally concerned with multi-layer cooling fabrics. Such fabrics may be employed in a wide variety of articles of clothing including, but not limited to, caps, visors, hats, vests, jackets, shirts, pants, and shorts. Embodiments within the scope of this disclosure may include any one or more of the following elements, and features of elements, in any combination: a fabric that includes a polyvinyl alcohol (PVA sponge) sponge layer; a fabric that includes a PVA sponge layer composed of a single piece of material; a fabric that includes a PVA sponge layer composed of multiple pieces of material; a fabric that includes multiple PVA sponge layers; a multi-layer fabric that includes a PVA sponge layer; a multi-layer fabric that includes a PVA sponge layer and a layer substantially composed of a material other than PVA sponge; a multi-layer fabric that includes a PVA sponge layer and polyester layer; a multi-layer fabric that includes a PVA sponge layer and layer that is about 100 percent polyester; a multi-layer fabric that includes a PVA sponge layer attached to a polyester layer; a multi-layer fabric that includes a PVA sponge layer attached to a layer that is about 100 percent polyester; a dual layer fabric that includes a polyvinyl alcohol (PVA sponge) layer; a dual layer fabric that includes a PVA sponge layer and a layer substantially composed of a material other than PVA sponge; a dual layer fabric that includes a PVA sponge layer and polyester layer; a dual layer fabric that includes a PVA sponge layer and layer that is about 100 percent polyester; a dual layer fabric that includes a PVA sponge layer attached to a polyester layer; a dual layer fabric that includes a PVA sponge layer attached to a layer that is about 100 percent polyester; and, an article of clothing that includes any of the aforementioned fabrics.

### BRIEF DESCRIPTION OF THE DRAWINGS

The appended drawings contain figures of some example embodiments to further clarify various aspects of the present disclosure. It will be appreciated that these drawings depict only some embodiments of the disclosure and are not intended to limit its scope in any way. The disclosure will be described and explained with additional specificity and detail through the use of the accompanying drawings in which:

FIG. 1 is a perspective view of an example of a visor that includes a PVA sponge layer;

FIG. 2 is a detail perspective view of a portion of a visor that includes a PVA sponge layer;

FIG. 3 is a detail perspective view of another portion of a visor that includes a PVA sponge layer;

FIG. 4 is a perspective view of a portion of a hat that includes a PVA sponge layer; and

FIG. 5 is a detail perspective view of a portion of a hat that includes a PVA sponge layer.

### DETAILED DESCRIPTION OF SOME EXAMPLE EMBODIMENTS

The present disclosure is generally concerned with multi-layer fabrics that may be employed in various articles of clothing. It should be noted that while such articles of clothing may be primarily employed by humans, this disclosure contemplates that the fabrics disclosed herein may also be employed in articles used primarily by animals, examples of which include a horse blanket, cooling coats for dogs, and any other articles that may aid in helping an animal regulate its body temperature when the animal is in a warm or hot environment.

In brief, articles of clothing may, in various implementations, include a PVA sponge layer which may or may not be attached to a layer of fabric to form a multi-layer fabric. By virtue of its porosity, and insulating qualities, the PVA sponge layer is able to hold a volume of a cool or cold fluid, such as water for example, and is able to maintain that fluid at a relatively cool temperature for a relatively long period of time, thus providing an ongoing cooling effect for a user of the article of clothing.

### General Aspects of Some Example Embodiments

In general, the fabrics disclosed herein may be employed in various articles of clothing including, but not limited to, caps, visors, hats, vests, jackets, socks, shirts, pants, shorts, towels, and neckerchiefs. These, and other, articles of clothing may be constructed of a variety of fabrics and materials including PVA sponge, polyester, cotton, nylon, and combinations of any of the foregoing. One, some, or all of the materials employed in a particular article of clothing may be any desired color, and may be substantially colorfast. PVA sponge layers of colors such as white and neutral may be substantially colorfast. Articles of clothing may be composed of a single piece of fabric, or multiple pieces of fabric. The entire article may be a multi-layer fabric or, alternatively, only a portion of an article may be a multi-layer fabric.

PVA sponge, sometimes referred to as polyvinyl alcohol (formalized) sponge, is a plastic sponge that has many of the same properties and qualities of a natural sea sponge. PVA sponge is a manufactured, non-woven copolymer and the processes for its manufacture differ somewhat from those of fabrics. Static-free and lint-free, PVA sponge is hydrophilic with porosities that may range, for example, from about 55% to about 95%. The surfaces of each sponge can be engineered for specific applications—from very smooth pores to large open pores like sea sponges. All deliver an exceptionally high volume and speed of absorption, actually holding many times the volume of liquid compared to materials such as a natural sea sponge or sheep-skin chamois. Elasticity and tensile strength properties help provide durability and may allow the material to last much longer than other materials.

Some attributes of PVA sponge may include one or more of the following: relatively rigid when dry; soft when wet; passive evaporative property; hydrophilic with regard to water and other fluids; may retain up to about 12 times its dry weight; substantially non-linting; non-scratching; mechanically strong and durable; abrasion-resistant; interconnected cell structure; colorfast, and can be dyed or silk screened; burns without generating toxic gases; good chemical resistance to acids, bases, and organic solvents; readily molded or shaped to a desired configuration; heat resistant to about 176 F dry, and about 248 F wet; pore size can be varied, for example, between about 60 microns and about 1500 microns; and, can be washed by hand or conventional wash machines.

The PVA sponge portions employed in various embodiments need not have any particular thickness, although depending upon the application, certain thicknesses may be relatively more desirable than other thicknesses. In the embodiments such as those disclosed herein, the thickness of one or more PVA sponge portions, when dry, may be in a range of about 1/16 of an inch to about ⅛ of an inch, although other thicknesses may additionally or alternatively be employed.

Finally, aspects such as the size, shape, thickness, location, configuration, and orientation of one or more PVA sponge portions of an article of clothing may be varied, and the scope of this disclosure is not limited to any particular size, shape, thickness, location, configuration, and orientation of one or more PVA sponge portions of an article of clothing.

### Particular Aspects of Some Example Embodiments

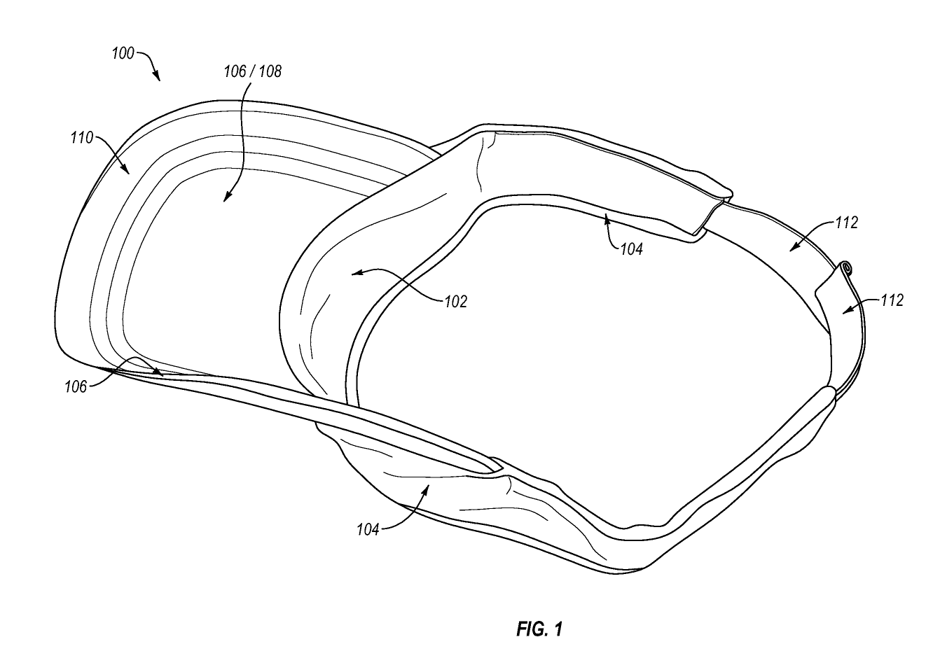

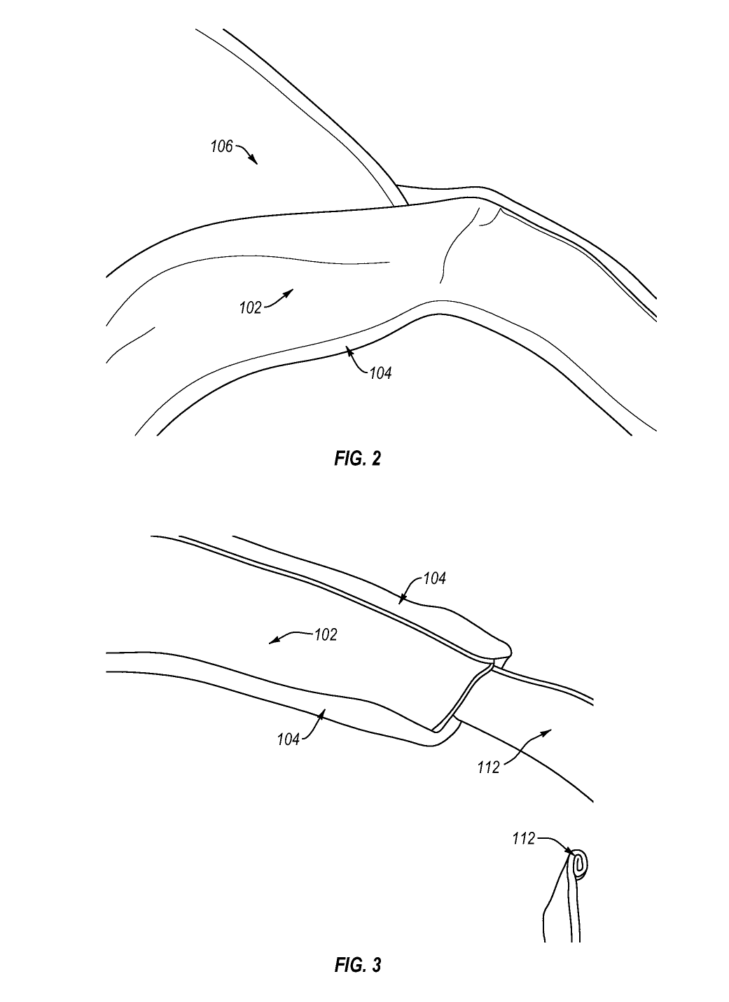

Directing attention first to FIGS. 1-3, aspects of an example of an article of clothing, at least a portion of which is implemented as a multi-layer fabric, are disclosed. The article of clothing is denoted generally at 100 and, in this example, takes the form of a visor. In this example, a PVA sponge layer 102 is shown that is attached to wicking layer 104 that may, for example, be partially or completely comprised of polyester. As indicated in FIG. 1, one or more other portions of the article of clothing 100 may likewise be made of, or include, a wicking material such as is employed in the wicking layer 104, although that is not required. By way of example, wicking material 106 may be employed on portions 108 of the article of clothing 100, such as the upper and lower surfaces of the visor element 110 for example. The same, or different, wicking materials may be employed in different portions of the article of clothing 100.

In the example of FIGS. 1-3, the PVA sponge layer 102 is sewn to the wicking layer 104, although the two layers may be attached in other ways as well such as, for example, with garment glue. In some embodiments, the two layers may be attached to each other by a combination of sewing and gluing, and/or by other methods. Although not shown in FIGS. 1-3, some embodiments of the article of clothing 100 may, but need not, include a wicking material 106 disposed on the PVA sponge layer 102 in such a way that the wicking material, rather than the PVA sponge layer 102, directly contacts the user when the visor is in use. This configuration may enable the wicking material 106 to transport sweat from the skin of the user, while the PVA sponge layer 102 beneath the wicking material 106 may provide a cooling effect to the user.

The PVA sponge layer 102 may extend around a substantial portion of an interior perimeter of the article of clothing. For example, the PVA sponge layer 102 may be configured and arranged to extend around all of the interior perimeter except for the adjustment element 112 (discussed below). Thus configured, the PVA sponge layer 102 may provide a cooling effect to a substantial portion of a circumference of the head of a user. In other embodiments, the PVA sponge layer 102 may be disposed only in select locations of the interior perimeter of the article of clothing.

With continued reference to the examples of FIGS. 1-3, the PVA sponge layer 102 may be constructed of a substantially continuous piece of material or, alternatively, may be constructed of multiple pieces of material attached together by gluing, sewing and/or any other suitable processes. The same is true of the material of the wicking layer 104, and of any other wicking material 106 employed elsewhere in the article of clothing 100.

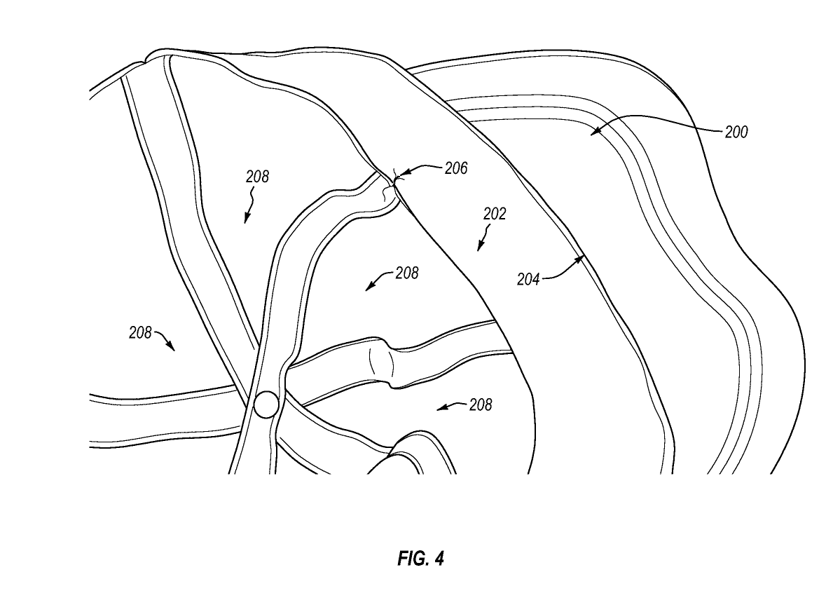

Finally, and as indicated in FIGS. 1 and 3, the article of clothing 100, whether in the form of a visor or some other article of clothing, may include an adjustment element 112 that enables a user to modify the size of the article of clothing 100 to fit the user. The adjustment element 112 may comprise one or more of a buckle, clip, hook-and-loop material such as Velcro®, and/or any other suitable mechanism(s) to enable adjustment and retention of a desired size of the article of clothing 100.

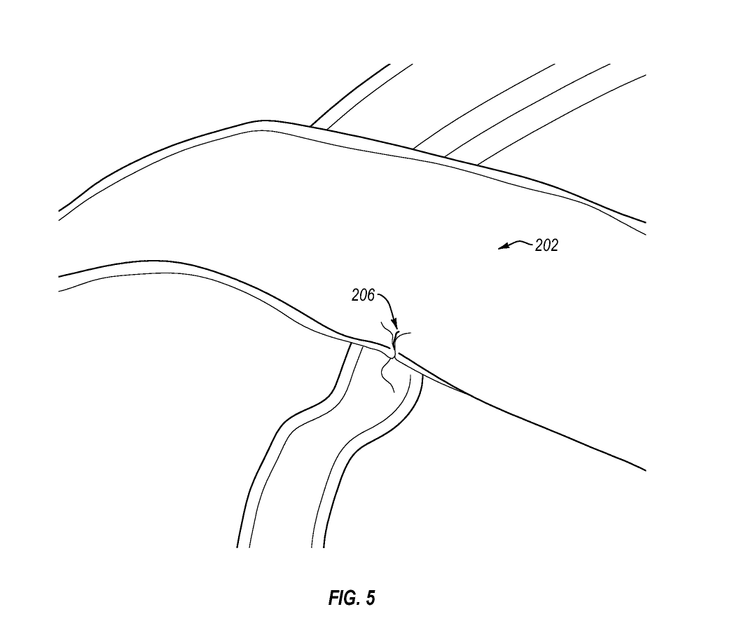

Directing attention now to FIGS. 4-5, aspects of an example of an article of clothing, at least a portion of which is implemented as a multi-layer fabric, are disclosed. The article of clothing is denoted generally at 200 and, in this example, takes the form of a cap. As the embodiment of FIGS. 4-5 is similar in many regards to that disclosed in FIGS. 1-3, the discussion of FIGS. 1-3 herein is germane to FIGS. 4-5 and the following discussion will focus only on selected differences between the two embodiments.

In the example of FIGS. 4-5, a PVA sponge layer 202 is provided that is attached at one edge 204, which may be substantially continuous, to another portion of the article of clothing 200, and attached at one or more discrete locations 206 to various respective portions of the article of clothing 200. Some, or substantially all, of the PVA sponge layer 202 may, but need not, be covered by a layer of wicking material (not shown), and the PVA sponge layer 202 may extend around a portion, or substantially all, of an interior circumference of the article of clothing 200.

With continued reference to FIGS. 4-5, a substantial portion of the article of clothing 200 may comprise a material, such as a wicking material for example, that permits airflow through the material. For example, one or more top portions 208 may comprise a material, such as a polyester wicking material for example, that enables airflow therethrough. Among other things, this construction and material may permit air to flow to enter the article of clothing 200 and pass over the PVA sponge layer so as to facilitate realization of an evaporative and/or convective cooling effect by the user. One or more of these effects may likewise be obtained, in a similar fashion, in other articles of clothing, such as the visor disclosed in FIGS. 1-3. As well, one or more top portions 208, and/or any other portion of the article of clothing 200 may comprise, or constitute, PVA sponge. Likewise, any portion of the article of clothing 100 may comprise, or constitute, PVA sponge either alone, or as part of a dual/multi-layer fabric.

Finally, any of the fabrics disclosed herein may be provided in a form that can be cut to any desired size and shape, and employed by the user as desired. In some instances, the fabric may be configured to be retro-fitted into an existing article of clothing. For example, the fabric may include a hook-and-loop construction, or other mechanism(s), that may permit a piece of the fabric to be releasably, or permanently, attached by a user in a desired position and orientation on an article of clothing. As well, where the piece of fabric is releasably attachable to an article of clothing, the piece of fabric may be interchanged with one or more other pieces of fabric so that a user can customize a cooling effect desired to be achieved by a particular article of clothing.

### Operational Aspects of Some Example Embodiments

At least some embodiments of the articles of clothing disclosed herein may operate as set forth in the following discussion. When the PVA sponge layer is relatively dry, it may be relatively stiff and rigid. The PVA sponge layer can be made soft and pliable by soaking it in water or other suitable fluid. Once soaked in this manner, the article of clothing that includes the PVA sponge layer may be able to provide evaporative and/or convective cooling effects to a user of the article of clothing.

More specifically, as a flow of air through and/or over the article of clothing comes into contact with the PVA sponge layer, the fluid held by the PVA sponge layer may provide a cooling effect to the user of the article of clothing. Such effect(s) may be provided whether or not the skin, for example, of a user is in direct contact with the PVA sponge layer. Where the PVA sponge layer is employed in conjunction with a wicking material, the wicking material may transfer moisture away from the user, and the PVA sponge layer may provide a cooling effect, as described above. In some instances, the wicking material may enhance airflow over the PVA sponge layer. Because one or more of the articles of clothing disclosed herein may include a multi-layer fabric with as few as two layers, namely, a PVA sponge layer and a wicking layer, the article of clothing may be relatively lighter and less bulky than articles of clothing that employ materials other than PVA sponge and/or that employ three or more layers.

Finally, it will be understood that the PVA sponge layer is one example of a structural implementation of a means for providing a cooling effect in an article of clothing. Any other materials of comparable functionality may alternatively be employed.

Although this disclosure has been described in terms of certain embodiments, other embodiments apparent to those of ordinary skill in the art are also within the scope of this disclosure.

What is claimed is:

1. An article of clothing, comprising:
a first portion including a multi-layer fabric that comprises:
a PVA sponge layer; and
a wicking layer substantially comprising polyester and attached to the PVA sponge layer; and
a second portion that comprises a wicking material,
wherein the article of clothing comprises a cap, or a visor.

2. The article of clothing as recited in claim 1, wherein the PVA sponge layer directly contacts a user when the article of clothing is in use by the user.

3. The article of clothing as recited in claim 1, wherein the wicking layer of the multi-layer fabric directly contacts a user when the article of clothing is in use by the user.

4. The article of clothing as recited in claim 1, wherein the PVA sponge layer has a first side that is substantially covered by the wicking layer.

5. The article of clothing as recited in claim 1, wherein the second portion of the article of clothing is substantially larger than the first portion of the article of clothing.

6. The article of clothing as recited in claim 1, wherein the multi-layer fabric extends around a portion of an interior perimeter defined by the article of clothing.

7. The article of clothing as recited in claim 1, wherein the multi-layer fabric consists only of the PVA sponge layer and the wicking layer.

8. The article of clothing as recited in claim 1, further comprising a third portion that substantially comprises PVA sponge.

9. An article of clothing, comprising:
a first portion including a dual-layer fabric that consists of:
a first PVA sponge layer; and
a second layer that is about 100 percent polyester, the second layer being attached to the first layer; and
a second portion that comprises a wicking material.

10. The article of clothing as recited in claim 9, wherein the article of clothing is one of caps, visors, hats, vests, jackets, socks, shirts, pants, shorts, towels, neckerchiefs, or articles of clothing for use by an animal.

11. The article of clothing as recited in claim 10, wherein the article of clothing is a cap or a visor, and wherein one or both of the first PVA sponge layer and the second polyester layer directly contacts a user when the cap or visor is worn on the head of a user.

12. The article of clothing as recited in claim 9, wherein the second portion comprises a plurality of panels of wicking material sewn together.

13. The article of clothing as recited in claim 9, wherein the dual-layer fabric extends around a portion of an interior perimeter defined by the article of clothing.

14. The article of clothing as recited in claim 9, wherein the first PVA sponge layer is a substantially continuous piece of material.

15. The article of clothing as recited in claim 9, wherein the first PVA sponge layer has a first side, a portion of which is covered by, and attached to, the second layer.

16. The article of clothing as recited in claim 15, wherein a substantial portion of the first side of the first PVA sponge layer is covered by, and attached to, the second layer.
